(19) United States
(12) Patent Application Publication
(10) Pub. No.: US 2008/0126948 A1
(43) Pub. Date: May 29, 2008

(54) METHOD FOR RETAINING AND ACTING ON REJECTED ELECTRONIC MEETINGS

(75) Inventors: Fonda Daniels, Cary, NC (US); Ruthie D. Lyle, Durham, NC (US); Michael Muller, Medford, MA (US); Andrew L. Schirmer, Andover, MA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/531,827

(22) Filed: Sep. 14, 2006

(51) Int. Cl. G06F 3/048

(52) U.S. Cl. 715/751

(57) ABSTRACT

A method for retaining and acting on rejected electronic meetings including accessing a calendar and scheduling application via a calendaring and scheduling system. Subsequently, reviewing an invitation to a meeting. Afterwards rejecting the invitation to the meeting. Then retaining information about the rejected meeting. Then displaying the information in all calendar views about the rejected meeting provided the user desires the information to be displayed.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates in general to electronic calendaring methods, and more particularly, to a method for retaining and acting on rejected electronic meetings.

2. Description of Background

Modern calendaring and scheduling (C&S) systems provide mechanisms for creating calendar events such as meetings and for sending invitations to other people so that they can participate in the meetings. Typically, the invitee is free to accept, reject, or ignore the invitation. Accepting a meeting generally adds an entry to the invitee's calendar with information about the meeting.

In most calendaring and scheduling (C&S) systems, the system warns the invitee of a conflict if the proposed meeting time overlaps any event already on the invitee's calendar. If there is such a conflict, or if the user simply wishes not to attend the meeting, the user can reject the invitation. This prevents the meeting from being added to the invitee's calendar and generally sends a notice of the rejection back to the meeting owner.

Sometimes, the invitee later wishes to change her mind and accept the invitation, either because the conflicting event has been removed, or because the meeting has a higher priority than the conflicting event, or because the user simply changes their mind for whatever reason. In most existing C&S systems, this is not possible because there is no way to revisit and accept the original invitation. The user could ask the meeting owner to reinvite him/her, but often he/she has forgotten all about the meeting because she no longer has a record of it. Some C&S systems may retain a record of the invitation somewhere, but they provide no calendar user interface that allows the user to see the previous invitation in context in a way that reminds them they might wish to interact with it again.

In other cases, a person may be informed about a meeting but not invited to join it. This non-invitee may wish to stay informed about changed to the meeting, including access to agendas and minutes, if available.

Thus, there is a need for a method for retaining, displaying and letting the user interact with meetings that he/she has rejected or delegated.

### SUMMARY OF THE INVENTION

The shortcomings of the prior art are overcome and additional advantages are provided through the provision of a method for retaining and acting on rejected electronic meetings including accessing a calendar and scheduling application via a calendaring and scheduling system. Then the method includes reviewing an invitation to a meeting. The method proceeds with rejecting the invitation to the meeting. Then retaining information about the rejected meeting. The method concludes with displaying the information in all calendar views about the rejected meeting provided the user desires the information to be displayed.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution for a method for retaining and acting on rejected electronic meetings.

### BRIEF DESCRIPTION OF THE DRAWINGS

The subject matter regarded as the invention is particularly pointed out and distinctly claimed in the claims at the conclusion of the specification. The foregoing and other objects, features, and advantages of the invention are apparent from the following detailed description taken in conjunction with the accompanying drawing in which:

FIG. 1 illustrates one example of a method for retaining and acting on rejected electronic meetings.

The detailed description explains the preferred embodiments of the invention, together with advantages and features, by way of example with reference to the drawings.

### DETAILED DESCRIPTION OF THE INVENTION

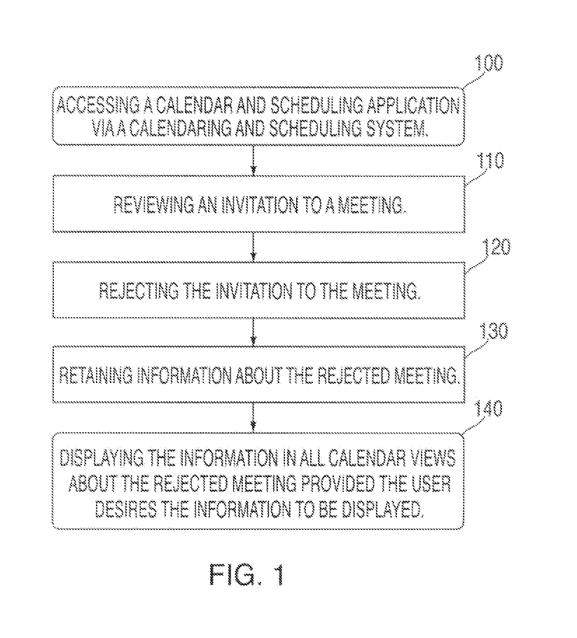

Referring to FIG. 1, a method for retaining and acting on rejected electronic meetings is shown. At step 100, a calendar and scheduling application operably associated with a calendaring and scheduling system is accessed. Afterwards, at step 110 an invitation to a meeting is reviewed. At step 120, information about the rejected meeting is retained. In conclusion at step 130, the information in all calendar views about the rejected meeting is displayed provided the user desires the information to be displayed. The rejected entries may optionally be kept up to date and the rejected entries displayed in the calendar views may optionally be changed accordingly.

The calendaring and scheduling system provides a plurality of functional operations. For instance, the calendaring and scheduling system permits the user to optionally select to be notified of changing circumstances regarding a meeting such that the user may later change position regarding attending a rejected meeting. Also, the calendaring and scheduling system permits the user to optionally select to display a rejected entry in all calendar views. Every meeting still appears on the user's calendar, marked in such a way that denotes that the user has rejected the meeting. The calendar view of a rejected entry may be displayed by at least one of the following forms, (i) by day, (ii) by week, (iii) by work week, (iiii) bi-weekly, (v) by month, (vi) by quarter and, (vii) by year.

Additionally, the calendaring and scheduling system permits the user to optionally select to be notified if a time slot previously conflicting with a rejected meeting becomes available. The calendaring and scheduling system also provides user interface (UI) affordances by means of the view entry for the rejected meeting for the user to inspect up-to-date information about the rejected meeting. The calendaring an scheduling system provides the UI affordances by means of the view entry for the rejected meeting for the user to be at least one of, (i) to accept or, (ii) to retrieve delegation for the previously rejected meeting. The calendaring and scheduling system also notifies the meeting chairperson when a rejected meeting is later accepted as well as notifies all associated logistical systems and logistical services of the rejected meeting. The UI provides a mechanism for at least one of the following selections by the user, (i) the user to hide or, (ii) the user to show the rejected meeting.

The user may optionally select to be alerted at the time of the rejected meeting, and optionally the user may elect to have that alert take place by way of a special indicator associated with the calendaring and scheduling system. The special indicator is used to indicate that the meeting has been rejected. A record about every meeting invite sent to the user is maintained by the calendaring and scheduling system in the user's calendar datastore. Rejected meetings may be shown in the calendaring and scheduling system by priority, which allows the user to place the more important meetings first in the list.

The functionality of meeting priority in the calendaring and scheduling system permits the order of multiple rejected meetings to be displayed and retained. The ordering maybe presented to the user in at least one of the following forms, (i) the calendar view or, (ii) in dialog view. A notification is generated by the calendaring and scheduling system and sent to the moderator/chairperson regarding the meeting to indicate that the meeting state has been changed to accepted when the user decides to change the status of the rejected meeting to accept the previously rejected meeting. Optionally, the user may select to suppress all such notifications and, the system provides a preference that allows the user to suppress such a notification for each particular meeting resulting in a finer-grained control over the notifications.

The calendaring and scheduling system informs the user about the meeting and permits the user to request the system enter that meeting into the user's calendar datastore marked as at least one of: (i) informational, (ii) not invited and, (iii) not planned to attend. The user may optionally request to be informed of updates to the meeting and may keep the meeting on their calendar for informational purposes as well as to allow access to it resources.

The calendaring and scheduling system also retains information about delegated meetings. The user may optionally select to display a delegated entry in all calendar views. The view includes but is not limited to displaying the delegated entry by at least one of, (i) by day, (ii) by week, (iii) by work week, (iiii) bi-weekly, (v) by month, (vi) by quarter and, (vii) by year. The user may optionally keep delegated entries up to date and may optionally select to change their display of such entries in the calendar view accordingly.

UI affordances are provided by means of the view entry for the delegated meeting for the user to inspect up-to-date information about the delegated meeting. The user may either (i) accept or, (ii) retrieve delegation information for the meeting via the calendaring and scheduling system. Furthermore, the calendaring and scheduling system provides UI affordances by means of the view entry for the delegated meeting for the user to inspect up-to-date information about the delegated meeting.

The system also notifies the meeting chairperson when a delegation is later withdrawn. When the invitee delegates attendance of the meeting to another person, the delegated meeting is still visible to the original invitee, along with information about the delegation. The original invitee may revoke the delegation and optionally accept the invitation at any time prior to the meeting. When the original invitee delegates the meeting, the system notifies the delegate, notifies the meeting organizer and optionally if the user selects this functionality, notifies the meeting participants.

Additional event attributes are possible, for example and not meant to be limiting, the user may optionally record a task for delegate to report to delegator after the meeting. The user may also optionally record a reminder for the delegator to look for the report from the delegate. Furthermore, the user may optionally record the delegation in the meeting notes, participant list, etc. If the original invitee revokes the delegation of the meeting, the system will notify the delegate, give the original invitee another chance to accept or reject the meeting invitation and, notify the meeting organizer. If participants were previously informed of the delegation, the system informs them that a change has occurred. If there was a task recorded for the delegate to report after the meeting, the user may optionally select to remove the task. Furthermore, if there was a reminder for the delegator to look for the report, the user may optionally select to remove the reminder. If the delegation information was recorded in the meeting note, participant list, etc. the user may select to remove it and update the appropriate information for the original invitee if he/she has accepted.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for retaining and acting on rejected electronic meetings, comprising:
accessing a calendar and scheduling application via a calendaring and scheduling system;
reviewing an invitation to a meeting;
rejecting the invitation to the meeting;
retaining information about the rejected meeting; and
displaying the information in all calendar views about the rejected meeting provided the user desires the information to be displayed.

2. The method of claim 1, wherein the rejected entries are kept up to date and the rejected entries displayed in the calendar views are changed accordingly.

3. The method of claim 2, wherein the calendaring and scheduling system permits the user to select to be notified of changing circumstances regarding a meeting such that the user may later change position regarding attending the rejected meeting.

4. The method of claim 3, wherein the calendaring and scheduling system permits the user to select to display a rejected entry in all calendar views.

5. The method of claim 4, wherein the calendaring and scheduling system permits the user to select to be notified if a time slot previously conflicting with a rejected meeting becomes available.

6. The method of claim 5, wherein the calendaring and scheduling system includes a user interface (UI) allowing the user to inspect up-to-date information about the rejected meeting.

7. The method of claim 6, wherein the calendaring and scheduling system notifies a meeting chairperson when a rejected meeting is later accepted.

8. The method of claim 7, wherein the calendaring and scheduling system permits the user to select to be alerted at the time of the rejected meeting with an indicator that the meeting has been rejected.

9. The method of claim 8, wherein every meeting still appears on the user's calendar, marked in a way that denotes that the user has rejected the meeting.

10. The method of claim 9, wherein the UI provides a mechanism for at least one of, (i) the user to hide rejected meetings and, (ii) the user to show the rejected meetings.

11. The method of claim 10, wherein the calendaring and scheduling system sends notification to a chairperson of the meeting to indicate that the meeting state has been changed to accepted when the user changes the status of the rejected meeting to accepted.

12. The method of claim 11, wherein the calendaring and scheduling system informs the user about the meeting and permits the user to request the system enter that meeting into the user's calendar datastore marked as at least one of, (i) informational, (ii) not invited and, (iii) not planed to attend, the user requesting to be informed of updates to the meeting and keeping the meeting on the user's calendar for information purposes as well as to allow access to it resources.

13. The method of claim 1, wherein the calendaring and scheduling system retains information about delegated meetings.

14. The method of claim 13, wherein the calendaring and scheduling system permits the user to optionally select to display a delegated entry in all calendar views.

15. The method of claim 14, wherein the calendaring and scheduling system permits the user to optionally keep delegated entries up to date and changes the user's display in the calendar view accordingly.

16. The method of claim 15, wherein the calendaring and scheduling system provides UI affordances by means of the view entry for the delegated meeting for the user to inspect up-to-date information about the delegated meeting.

17. The method of claim 16, wherein the calendaring dan scheduling system provides UI affordances by means of the view entry for the delegated meeting for the user to at least one of, (i) accept and, (ii) retrieve delegation for the meeting.

18. The method of claim 17, wherein the calendaring and scheduling system notifies the meeting chairperson when a delegation is later withdrawn.

19. The method of claim 18, wherein when the invitee delegates attendance of the meeting to another person, the delegated meeting is still visible to the original invitee, along with information about the delegation and, the original invitee can revoke the delegation and optionally accept the invitation at any time prior to the meeting.

20. The method of claim 19, wherein when the original invitee delegates the meeting, the system notifies the delegate, notifies the meeting organizer and optionally via the user notifies the meeting participants.
